(19) United States
(12) Patent Application Publication
(10) Pub. No.: US 2011/0032262 A1
(43) Pub. Date: Feb. 10, 2011

(54) SEMICONDUCTOR INTEGRATED CIRCUIT FOR DISPLAYING IMAGE

(75) Inventors: Toshiyuki Furusawa, Tokyo (JP); Hitoshi Nemoto, Kanagawa-ken (JP); Isao Ooigawa, Kanagawa-ken (JP); Nariyuki Fukuda, Kanagawa-ken (JP); Hiroyuki Fujioka, Kanagawa-ken (JP); Noriyuki Moriyasu, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/716,782

(22) Filed: Mar. 3, 2010

(30) Foreign Application Priority Data
Aug. 6, 2009 (JP) 2009-183870

(51) Int. Cl. G09G 5/36

(52) U.S. Cl. 345/545

(57) ABSTRACT

A normal bus and an extension bus having the same bit width as the normal bus are provided. A line buffer has a plurality of line regions to store pixel data of input image data. A line buffer writing control portion controls a direction in which the pixel data is to be written to the line buffer. A line buffer reading control portion reads out the pixel data stored in the line buffer and to output the read out pixel data to the buses selectively. A frame memory writing control portion controls a destination in a frame memory to which the pixel data obtained from the buses is to be written. An address control portion controls a writing address in the frame memory. The line buffer writing control portion controls the writing direction in the line buffer in accordance with an image rotation command signal.

### CROSS REFERENCE TO RELATED APPLICATION

This application is based upon and claims the benefit of priority from the prior Japanese Patent Application No. 2009-183870, filed on Aug. 6, 2009, the entire contents of which are incorporated herein by reference.

### FIELD OF THE INVENTION

The invention relates to a semiconductor integrated circuit to display images.

### DESCRIPTION OF THE BACKGROUND

A typical method for outputting a still image or a moving image to a display device is that image data of each frame is stored in a frame memory and then the image data is read from the frame memory to display the image. In this case, the data writing is performed into the frame memory while incrementing writing address sequentially.

Image display functions of equipment such as a cellular phone have been complicated increasingly, recently. For example, such processing as magnification/reduction or rotation of an original image has been required. Japanese Patent Application Publication No. 2007-133188 (FIGS. 1, pp. 7 to 8) discloses equipment which connects a scaler to a frame memory. The equipment performs magnification/reduction of an image data read out from the frame memory so that the read out image is magnified/ scaled down.

In the case of displaying a moving image, it is necessary to display the image at a constant frame rate. The higher the frame rate is, the smoother the displayed moving image is. Accordingly, recent cellular phones employ a system, that a one-segment broadcasting image of an original frame rate of 15 frames/second is displayed at 60 frames/second, for example. This system shortens the frame display interval so that it also shortens the lapse of time from a time point when the image data is read from a frame memory to a time point when the read image data is outputted to a display device.

However, the equipment disclosed in the above mentioned patent publication performs image processing on image data read out from a frame memory using a scaler so that the equipment is difficult to increase the frame rate to achieve a higher operation speed.

### SUMMARY OF THE INVENTION

An aspect of the present invention provides a semiconductor integrated circuit comprising a normal bus, an extension bus having the same bit width as the normal bus, a frame memory having a memory width equal to an integer multiple of the number of bits of the normal bus, a line buffer having a plurality of line regions to store pixel data of input image data, a line buffer writing control portion to control a direction in which the pixel data is to be written to the line buffer, a line buffer reading control portion to read out the pixel data stored in the line buffer and to output the read out pixel data to the normal bus and the extension bus selectively, a frame memory writing control portion to control a destination in the frame memory to which the pixel data obtained from the normal bus and the extension bus is to be written, and an address control portion to control a writing address in the frame memory, wherein the line buffer writing control portion controls the writing direction in the line buffer in accordance with an image rotation command signal, the line buffer reading control portion divides the read out pixel data and outputs the divided pixel data to the normal bus and the extension bus respectively, and the frame memory writing control portion controls the writing destination in the frame memory of the pixel data obtained from the normal bus and the extension bus.

### BRIEF DESCRIPTION OF THE DRAWINGS

FIG. 1 is a block diagram showing an example of a configuration of a semiconductor integrated circuit according to a first embodiment of the invention.

FIGS. 2A to 2C are explanatory diagrams of normal writing to a frame memory.

FIGS. 3A, 3B are other explanatory diagrams of the normal writing to the frame memory.

FIGS. 4A to 4C are diagrams to explain writing a 90-degree rotated image in a frame memory.

FIGS. 5A, 5B are other diagrams to explain writing the 90-degree rotated image in the frame memory.

FIGS. 6A to 6C are diagrams to explain writing a four times magnified image in the frame memory.

FIG. 7 is another diagram to explain writing the four times magnified image in the frame memory.

FIG. 8 is a further another diagram to explain writing the four times magnified image in the frame memory.

FIG. 9 is a block diagram showing an example of a configuration of a semiconductor integrated circuit according to a second embodiment of the invention.

FIGS. 10A, 10B are diagrams to explain writing to a frame memory in the case of generating a copy image.

FIG. 11 is a block diagram showing an example of a configuration of a semiconductor integrated circuit according to a third embodiment of the invention.

FIG. 12 is a block diagram showing an example of a configuration of a semiconductor integrated circuit according to a fourth embodiment of the invention.

FIGS. 13A, 13B are diagrams to explain writing to a frame memory in the case of generating a right and left reversed image.

FIGS. 14A, 14B are diagrams to explain writing to a frame memory in the case of generating a top and bottom reversed image.

FIGS. 15A to 15C are diagrams to explain writing to a frame memory in the case of generating a composite display processing image.

FIG. 16 is another diagram to explain writing to the frame memory in the case of generating the composite display processing image.

FIG. 17 is a further another diagram to explain writing to the frame memory in the case of generating the composite display processing image.

### DETAILED DESCRIPTION OF THE INVENTION

Hereinafter, embodiments of the invention will be described with reference to the drawings. In the drawings, the same reference numerals denote the same portions respectively.

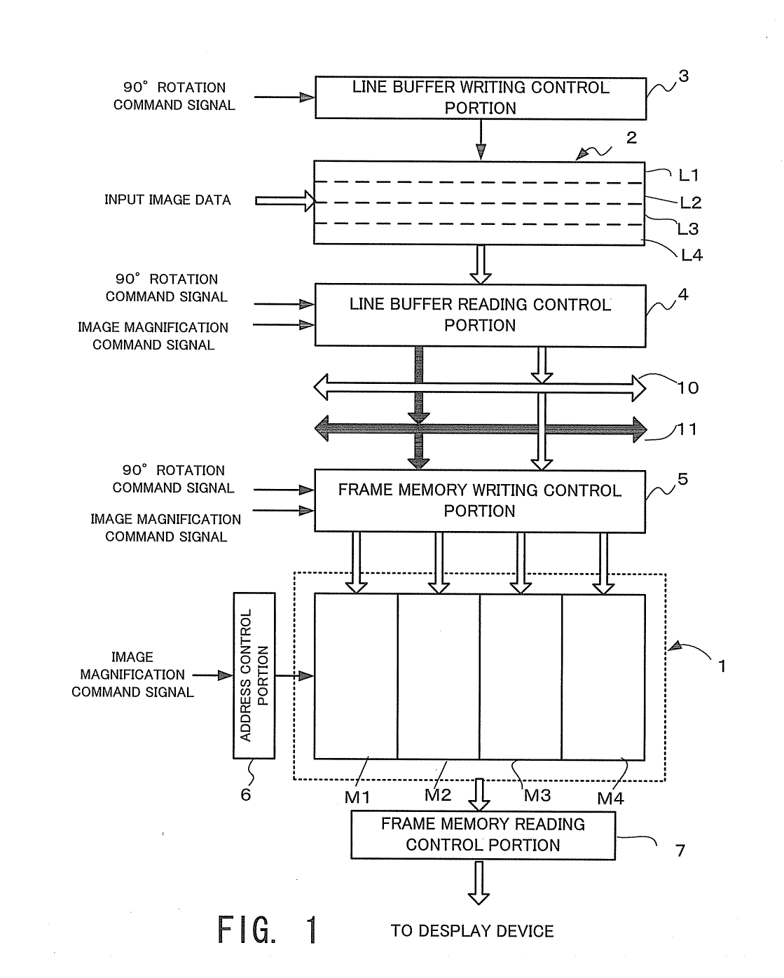

A first embodiment of a semiconductor integrated circuit according to the invention will be described with reference to FIGS. 1 to 8.

FIG. 1 is a block diagram showing the first embodiment.

As shown in FIG. 1, the semiconductor integrated circuit according to the embodiment includes a frame memory 1, a line buffer 2, a line buffer writing control portion 3, a line buffer reading control portion 4, a frame memory writing control portion 5, an address control portion 6, a frame memory reading control portion 7, a normal bus 10, and an extension bus 11. Pixel data to be inputted to the line buffer 2 is 24 bits in size, for example.

The normal bus 10 is a parallel type and is used for transferring pixel data and versatile data. The extension bus 11 is a parallel type and is used for processing images. The line buffer 2 stores pixel data of a plurality of lines of inputted image data into a plurality of line regions L1 to L4. In the embodiment, four lines are used.

The line buffer writing control portion 3 controls a direction in which the pixel data is written to the line buffer 2, in accordance with a 90-degree image rotation command signal.

The line buffer reading control portion 4 determines whether a destination, to which the image data read from the line buffer 2 is to be outputted, should be only the normal bus or both of the normal bus and the extension bus, in accordance with the image rotation command signal and an image magnification command signal.

The frame memory writing control portion 5 controls a destination in the frame memory 1, to which the image data inputted through the normal bus or the extension bus is to be written, in accordance with the image rotation command signal and the image magnification command signal.

The address control portion 6 controls a writing address in the frame memory 1, in accordance with the image magnification command signal.

The frame memory reading control portion 7 changes the image data read from the frame memory 1 into display image data and outputs the data to a display device (not shown).

The embodiment will hereinafter be described for an example where the bus width (number of bits) of the normal bus 10 is the same as the number of bits of image data, 24 bits, for example. However, the bit width of the normal bus 10 is not limited to 24 bits. For example, the bus width of the normal bus 10 may be the same as the number of bits of a plurality of pixels.

Further, the bus width (number of bits) of the extension bus 11 matches that of the normal bus 10.

The number of bits of the memory width of the frame memory 1 is set to an integer multiple of the number of bits of the normal bus 10. The frame memory 1 is divided into memory blocks. In the embodiment, the frame memory 1 is divided into four memory blocks M1 to M4, for example. The number of bits of the block width of each of the memory blocks M1 to M4 corresponds to an integer multiple of the number of bits of the normal bus 10.

If the number of bits of the normal bus 10 corresponds to an integer multiple of the number of bits of the pixel data as described above, the number of bits of the width of each of the memory blocks M1 to M4 of the frame memory 1 is also equal to the number of bits of the pixel data or an integer multiple of the number of bits of the pixel data.

In the embodiment, one piece of image data is stored in lines of any one of the memory blocks M1 to M4.

Therefore, it is easy to perform address control when image data is written to the frame memory 1 or the image data is read from the frame memory 1.

In the embodiment, the “image data writing direction” indicates either a direction in which one line of image data is to be written sequentially in incremental order of addresses starting from an initial address of each of the line regions L1 to L4, or a direction in which the image data is to be written from L1 toward L4 over the same addresses. Writing in the former direction is referred to as “address-direction writing” and writing in the latter direction writing as “line-direction writing”.

The line buffer writing control portion 3 performs address-direction writing if 90-degree rotation is instructed by the image rotation command signal. If the rotation is not instructed, i.e., in the case of normal display, the line buffer writing control portion 3 performs line-direction writing.

The line buffer reading control portion 4 controls whether the output destination of image data read from the line buffer 2 should be only the normal bus 10 or both of the normal bus 10 and the extension bus 11, in accordance with the image rotation command signal and the image magnification command signal.

Unlike the case of writing to the line buffer 2, the direction in which the image data is read from the line buffer 2 is always from L1 toward L4 (line direction) over the same addresses irrespective of whether the image is rotated or not, or magnified or not.

If the image is not rotated nor magnified, that is, in the case of normal image display, the line buffer reading control portion 4 outputs the image data read from the line buffer 2 only to the normal bus 10.

If 90-degree rotation is instructed by the image rotation command signal, the line buffer reading control portion 4 reads two addresses of the image data from the line buffer 2 simultaneously and distributes each address of the data to each of the normal bus 10 and the extension bus 11.

If image magnification is instructed by the image magnification command signal, the line buffer reading control portion 4 reads the image data from the line buffer 2 sequentially and outputs the same data to both of the normal bus 10 and the extension bus 11.

In accordance with the image rotation command signal and the image magnification command signal, the frame memory writing control portion 5 controls the destination in the frame memory 1 to which the image data input from the normal bus 10 and the extension bus 11 is to be input.

If 90-degree rotation is instructed by the image rotation command signal, the frame memory writing control portion 5 sets writing destinations of the image data, which are outputted to the normal bus 10 and the extension bus 11, to different ones of the memory blocks M1 to M4 in the frame memory 1.

The frame memory writing control portion 5 writes the image data output to the normal bus 10 into the memory block M1 and the image data output to the extension bus 11 into the memory block M2, for example. In this case, the writing bit order is set to be the same in the respective memory blocks.

If image magnification is instructed by the image magnification command signal, the frame memory writing control portion 5 controls a writing bit position in the frame memory 1 such that the writing destination of the image data outputted to the normal bus 10 and the writing destination of the image data outputted to the extension bus 11 neighbor each other.

The address control portion 6 controls selection of writing addresses in the frame memory 1 in accordance with the image magnification command signal. The address control portion 6 simultaneously selects consecutive addresses corresponding to a vertical magnification factor specified by the image magnification command signal. If the vertical magnification factor is two, for example, the address control portion 6 selects two consecutive addresses simultaneously. In this manner, the identical image data is written into those consecutive addresses.

A relationship between the image display processing and the frame memory writing operation in the embodiment will be described using a detailed example.

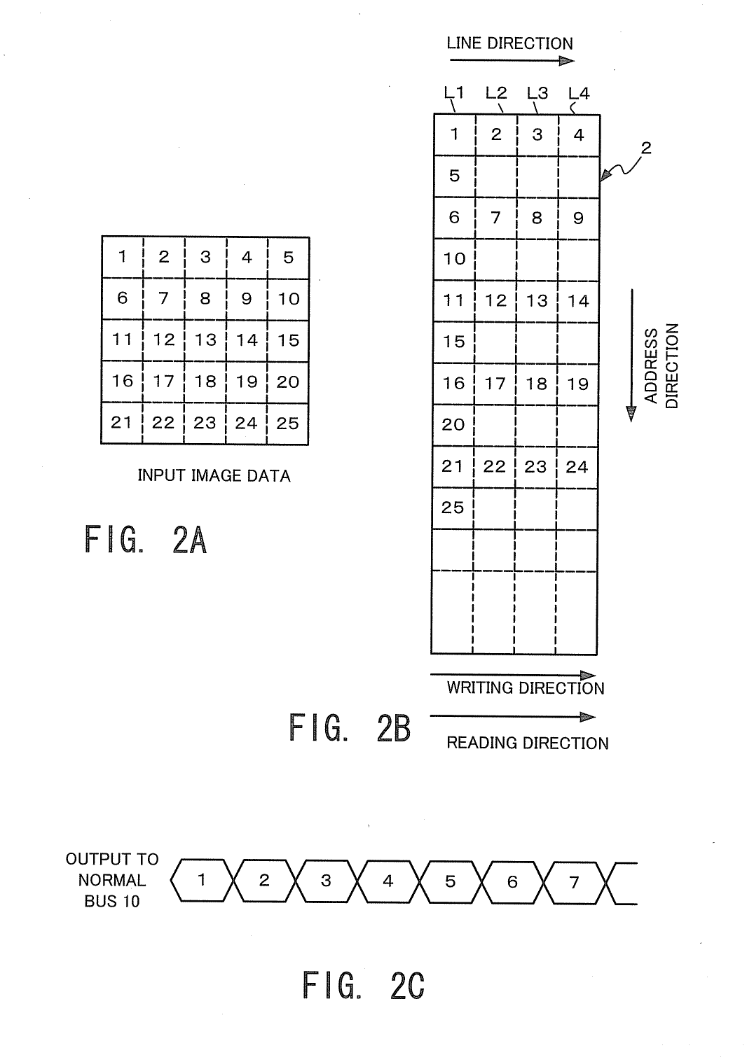

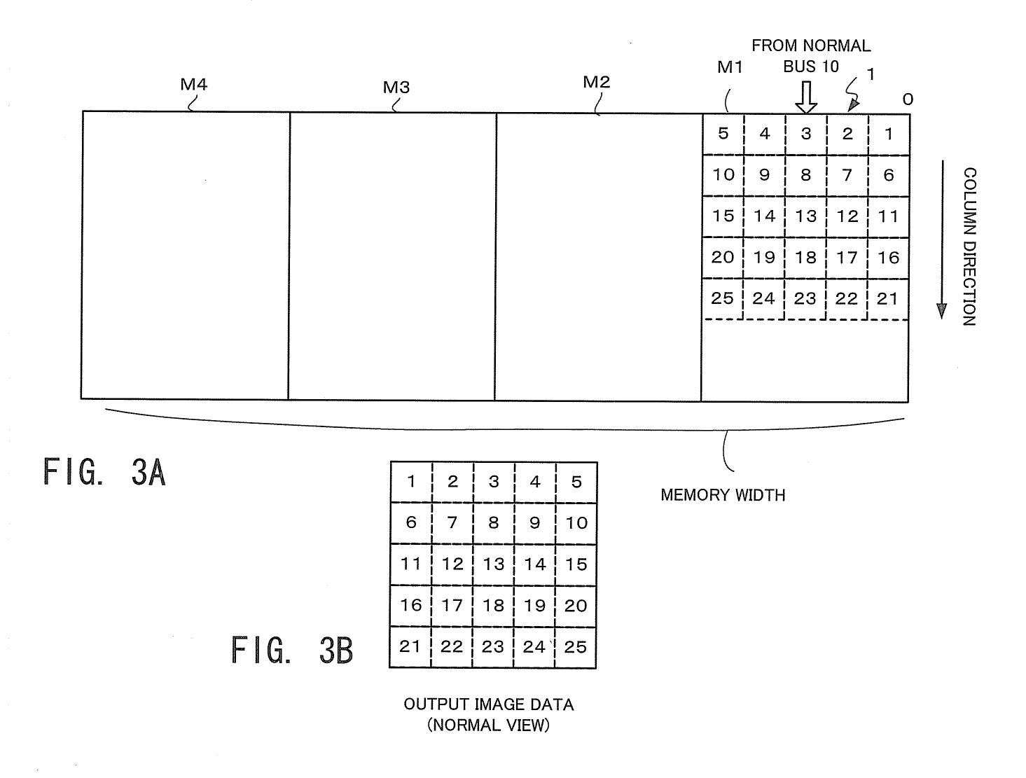

Operations, which performed in normal display, will be described with reference to FIGS. 2A to 2C, 3A, and 3B. Input image data is composed of 25 pixel data 1 to 25 which are arranged in an array of five (lines)×five (columns) as shown in FIG. 2A.

In the case of normal display, the line buffer writing control portion 3 writes the pixel data of pixels 1 to 25 into the line buffer 2 in the line direction as shown in FIG. 2B.

Subsequently, the line buffer reading control portion 4 reads the pixel data 1 to 25 from the line buffer 2 in the line direction and outputs the pixel data to the normal bus 10 as shown in FIG. 2C.

The data output to the normal bus are sequentially written into the memory block M1 of the frame memory 1 under a condition that the writing destination is controlled by the frame memory writing control portion 5, as shown in FIG. 3A. In FIG. 3A, the frame memory 1 has a memory width and is given an address for each pixel storing region.

The image data read from the frame memory 1 is normally displayed by the frame memory reading control portion 7 as shown in FIG. 3B.

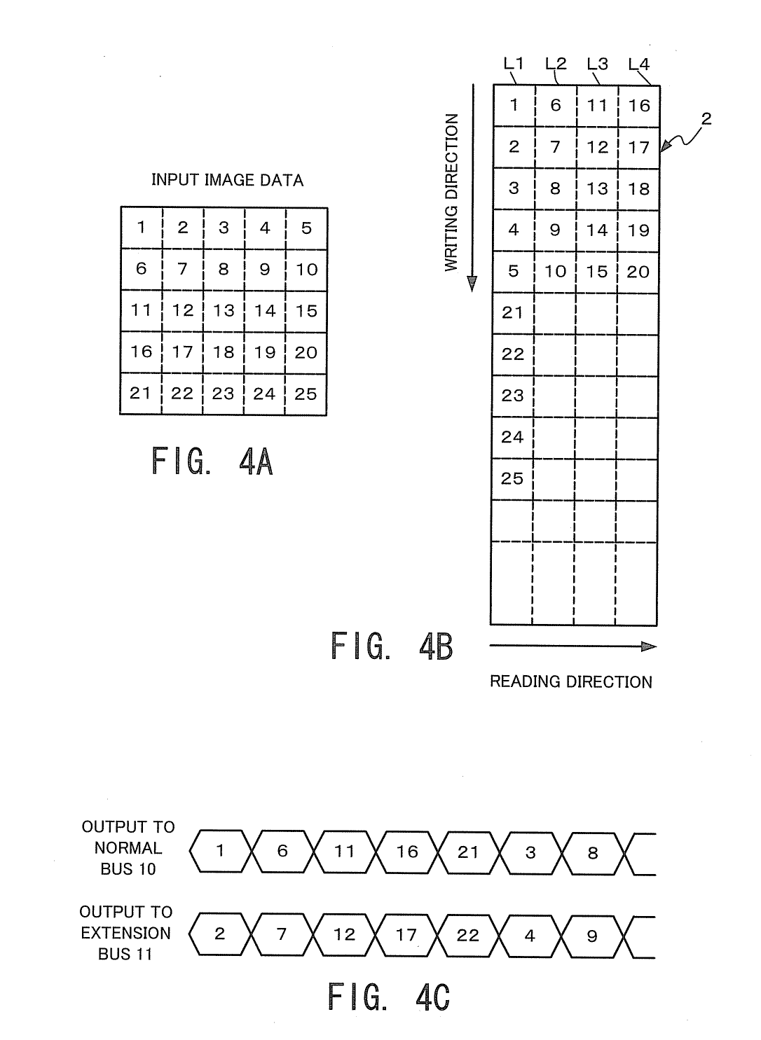

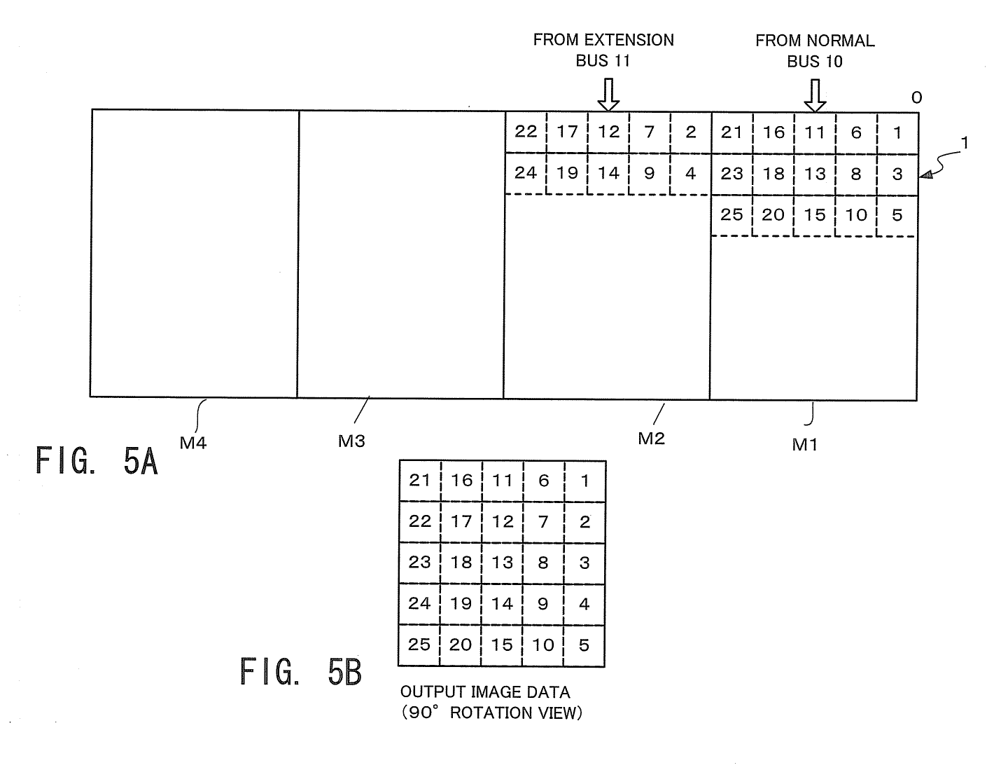

Operations for rotating an input image by 90 degrees clockwise and for displaying the image will be described with reference to FIGS. 4A to 4C, 5A, and 5B.

In order to rotate an input image shown in FIG. 4A by 90 degrees clockwise and to display the image, the line buffer writing control portion 3 writes the pixel data 1 to 25 of the input image into the line buffer 2 in the address direction as shown in FIG. 4B.

Subsequently, the line buffer reading control portion 4 simultaneously reads two addresses of image data from the line buffer 2 and distributes each of the two addresses to the normal bus 10 and the extension bus 11.

FIG. 4C shows those outputs to the normal bus 10 and the extension bus 11. The normal bus 10 is provided with pixel data 1, 6, 11, 16, 21, 3, 8, . . . sequentially, while the extension bus 11 is simultaneously provided with the pixel data 2, 7, 12, 17, 22, 4, 9, . . . sequentially.

The frame memory writing control portion 5 sets the mutually different memory blocks in the frame memory 1 as a writing destination of the image data outputted from the normal bus 10 and a writing destination of the image data outputted from the extension bus 11. As shown in FIG. 5A, the pixel data 1, 6, 11, 16, 21, 3, 8, . . . outputted from the normal bus 10 are written into the memory block M1, while the pixel data 2, 7, 12, 17, 22, 4, 9, . . . outputted from the extension bus 11 are written into the memory block M2, for example.

In this case, when the frame memory reading control portion 7 reads the image data from the frame memory 1, the image data are read from the memory blocks M1, M2 alternately. By such alternate reading, output image data rotated by 90 degrees clockwise is obtained and displayed as shown in FIG. 5B.

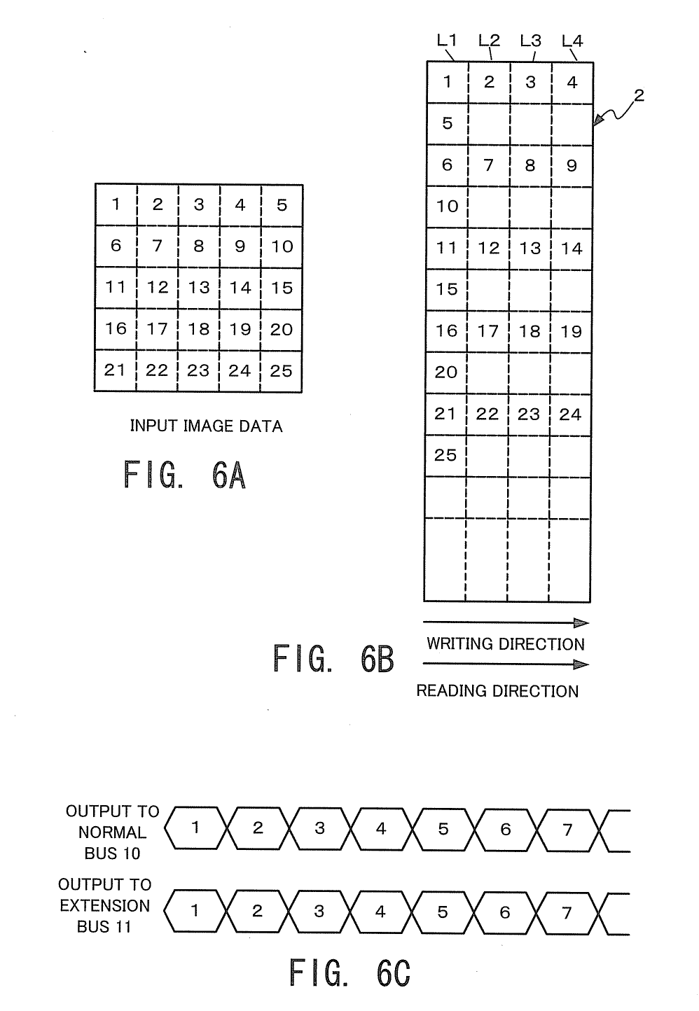

Operations, where an input image is magnified four times (two times vertically and two times horizontally) and the magnified image is displayed, will be described with reference to FIGS. 6A to 6C, 7, and 8.

In order to magnify an input image shown in FIG. 6A four times and display the image, the line buffer writing control portion 3 writes the pixel data 1 to 25 of the input image into the line buffer 2 in the line direction as shown in FIG. 6B.

Subsequently, the line buffer reading control portion 4 reads the written image data from the line buffer 2 and, as shown in FIG. 6C, outputs the read data to the normal bus 10 and the extension bus 11 simultaneously. For magnifying display, the identical image data as that shown in FIG. 6C is simultaneously outputted to the normal bus 10 and the extension bus 11 over again.

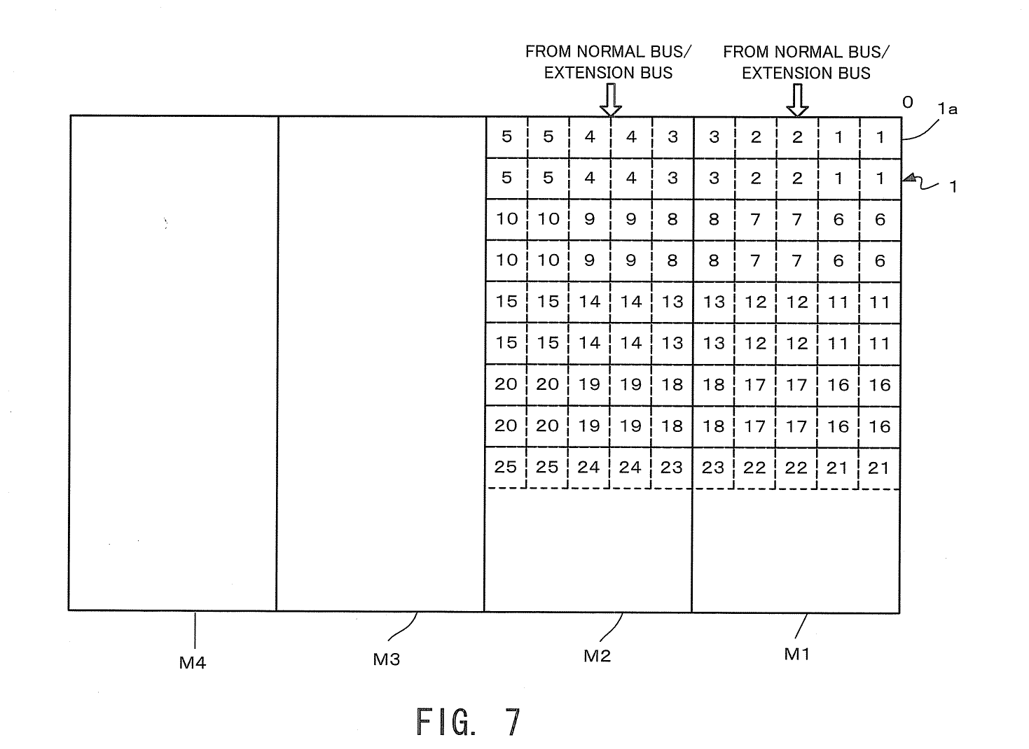

The writing bit positions in the memory frame 1 of the image data output to the normal bus 10 and the extension bus 11 respectively are controlled by the frame memory writing control portion 5 in accordance with the horizontal magnification factor of “2” such that those output data have their writing destinations neighboring each other horizontally in FIG. 7.

In accordance with the vertical magnification factor of “two (2)”, the address control portion 6 sequentially selects two addresses consecutive vertically in FIG. 7 and saves the two identical image data in those selected addresses respectively.

As a result, as shown in FIG. 7, the image data is written into the frame memory 1 such that each pair of the identical pixel data is disposed in one line 1a in the memory width direction and, further, each pair of the lines having the identical pixel values is disposed.

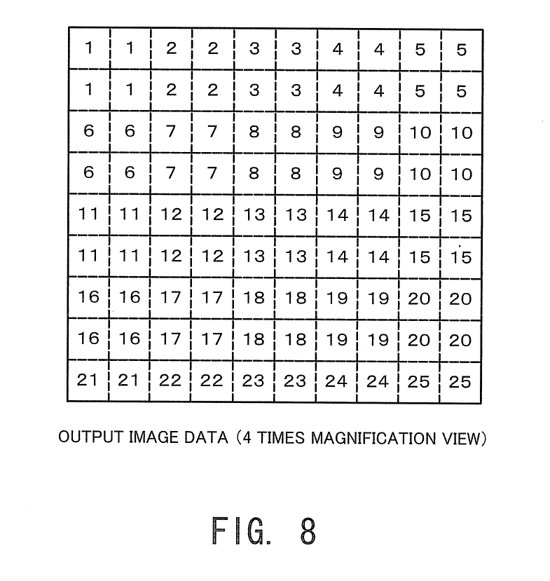

In order to display an image, the frame memory reading control portion 7 conducts control so that the image data is read from the memory blocks M1, M2 in the frame memory 1 alternately. The image data read from the frame memory 1 is displayed as a fourfold magnified image as shown in FIG. 8.

In the embodiment, the directions, in which writing and reading are performed in the line buffer 2, are changed to shift the arrangement order of pixel data to be output to the buses 10, 11 and to control the column-directional writing addresses in the frame memory 1, in accordance with a type of display such as rotated display or enlarged display. By conducting such control, it is possible to efficiently write the image data for rotated display or magnified display into the frame memory 1 while rotating or magnifying the image data.

A comparative example may be thought, in which image data processed for magnification or rotation in advance is written into a frame memory and then the written data is read from the frame memory to output the read data as it is to a display device. However, in this case, the magnified image requires a larger amount of data to be written into the frame memory. In addition, the rotated image causes the writing addresses in the frame memory to be updated irregularly for each rotational processing. As a result, the efficiency of writing into the frame memory is deteriorated. In contrast, in the embodiment, as described above, the data can be written into the frame memory efficiently.

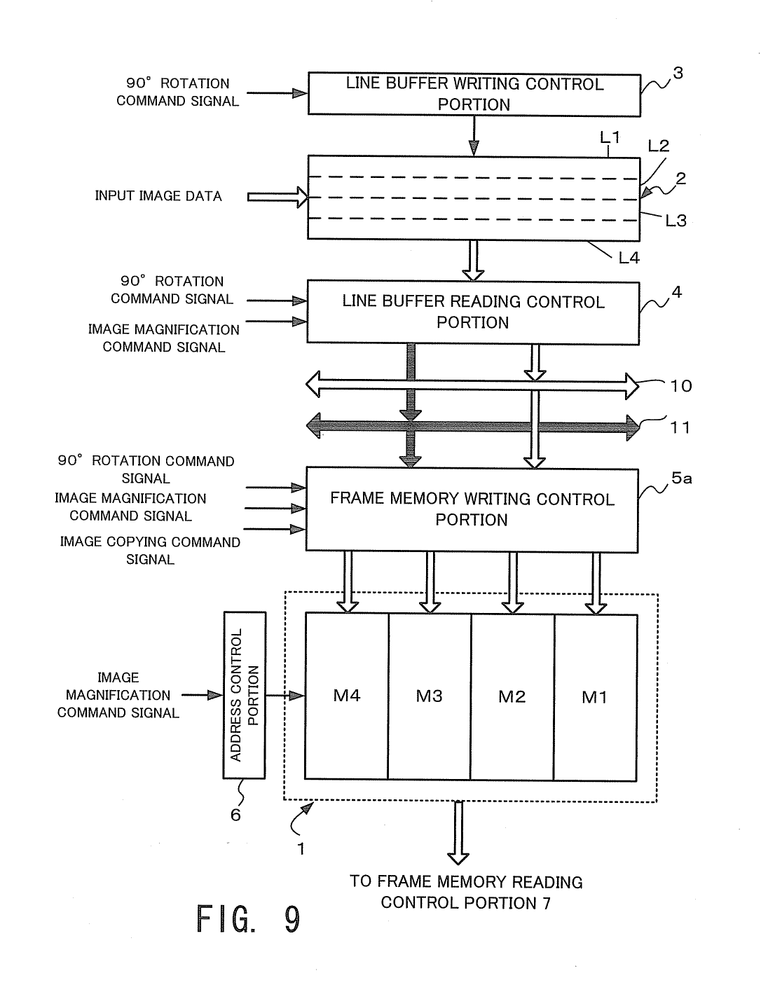

FIG. 9 is a block diagram showing an example of the configuration of a semiconductor integrated circuit according to a second embodiment of the invention.

The embodiment is arranged so that two identical image data may be written into a frame memory in order to display the identical image data on two display devices.

In a semiconductor integrated circuit in the embodiment, a frame memory writing control portion is provided with an image copy command signal.

In FIG. 9, if instructed by the image copy command signal to copy image data, a frame memory writing control portion 5a writes the image data outputted to a normal bus 10, or to the normal bus 10 and an extension bus 11 into two different blocks of memory blocks M1 to M4 in a frame memory 1.

An example, where image writing is performed into the frame memory 1 by the frame memory writing control portion 5a, will be described.

In this example, such processing as shown in FIGS. 2A to 2C is performed on image data for normal display. In the case of the normal display, pixel data is output to the normal bus 10 in the order of pixels as shown in FIG. 2C.

The frame memory writing control portion 5a designates the memory blocks M1, M3 of the frame memory 1, for example, in order to determine destinations to which the pixel data outputted to the normal bus 10 is to be written.

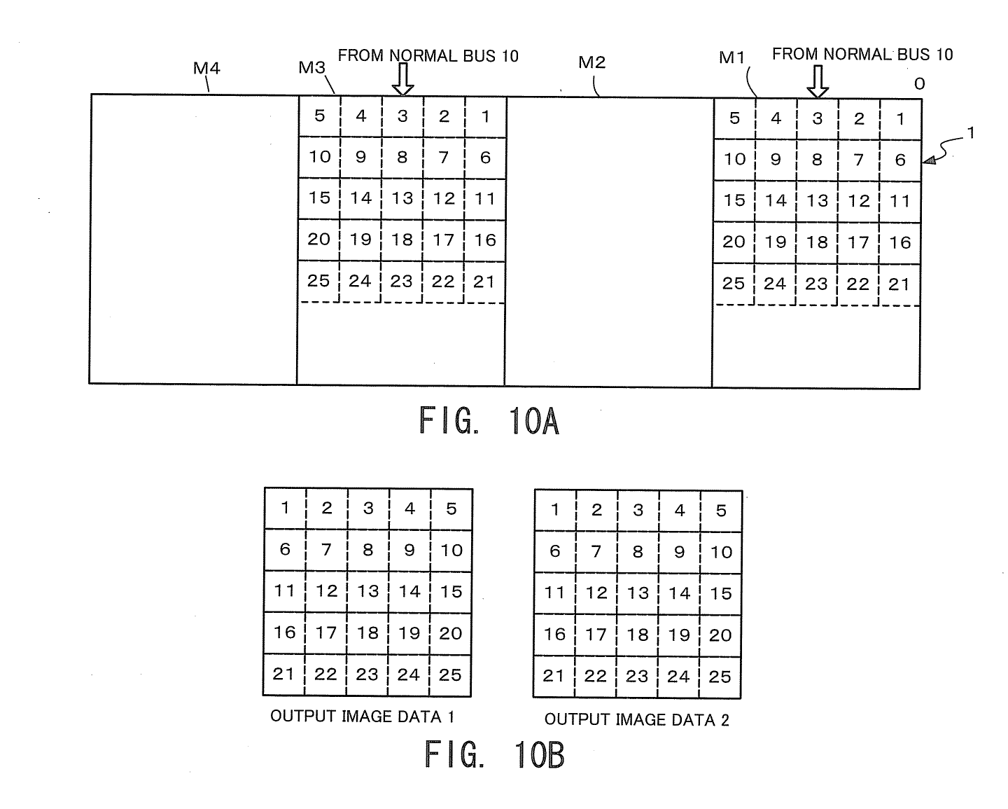

As a result, as shown in FIG. 10A, completely the same image data is written simultaneously into the memory blocks M1, M3 of the frame memory 1 by the frame memory writing control portion 5a.

To display the image, the data read from the memory blocks M1, M3 by a frame memory reading control portion 7 are outputted to display devices different from each other. By such output, an output image 1 is displayed on one of the display devices. An output image 2, which is identical to the output image 1, is displayed on the other display device as shown in FIG. 10B.

In the embodiment, two identical image data can be written into the frame memory easily.

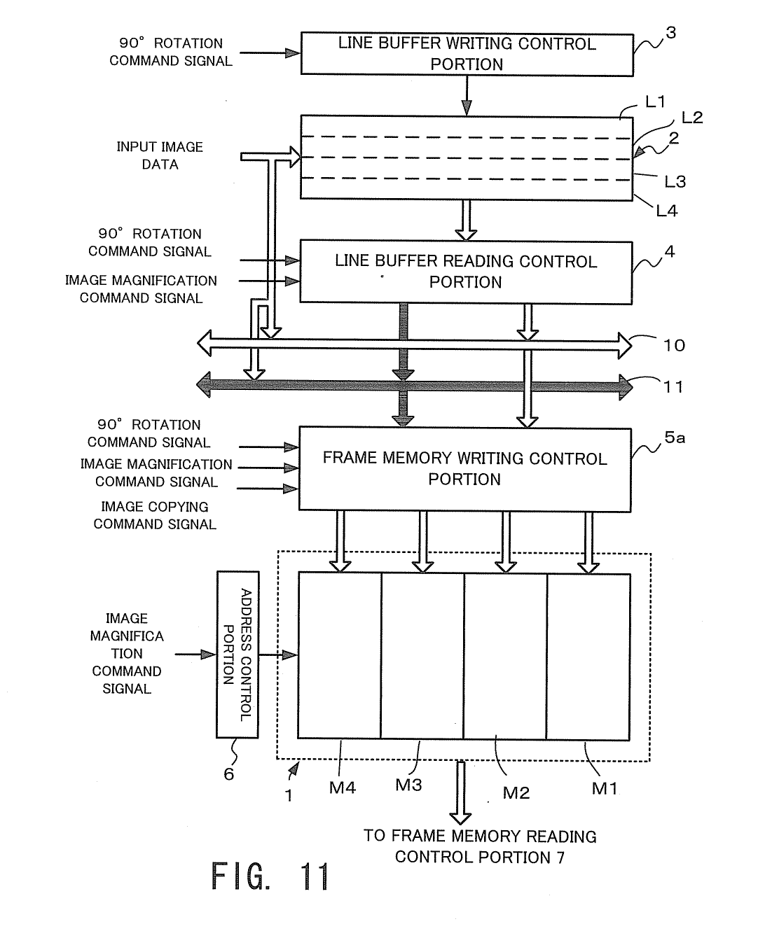

FIG. 11 is a block diagram showing an example of the configuration of a semiconductor integrated circuit according to a third embodiment of the invention.

In the embodiment, in the case of only magnifying or copying an input image without rotating the image, data of an input image can be transferred directly to a normal bus 10 and an extension bus 11 without being stored in a line buffer 2.

In the case of only magnifying an input image without rotating the image, data of the input image is transferred to both of the normal bus 10 and the extension bus 11. Further, in the case of only copying an input image without rotating the image, data of the input image is transferred to the normal bus 10.

The input image data transferred to the normal bus 10 or the extension bus 11 is magnified and copied in the same processing as that described in the first and second embodiments.

In the embodiment, the line buffer is not used in the processing of magnifying or copying an image without rotating the image, so that writing can be performed to the frame memory 1 speedily.

Moreover, in the embodiment, power consumption can be reduced for an amount decreased by no use of the line buffer 1.

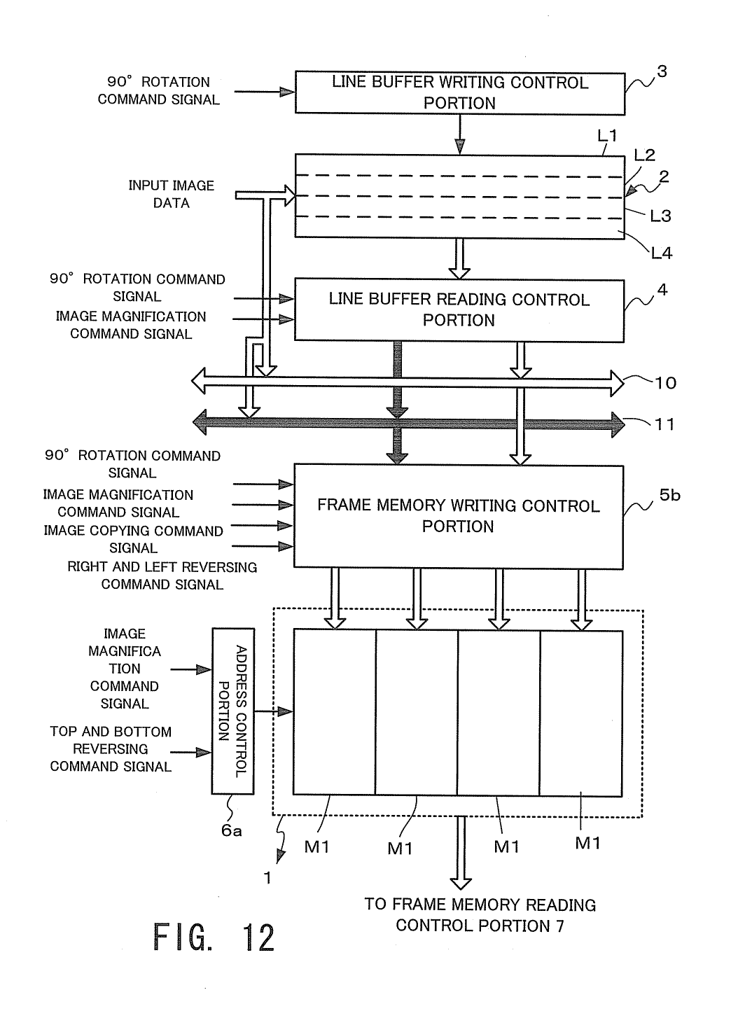

FIG. 12 is a block diagram showing an example of the configuration of a semiconductor integrated circuit according to a fourth embodiment of the invention.

In the embodiment, it is possible to write data for displaying a right and left reversed image or a top and bottom reversed image into a frame memory.

When a right and left reversing command signal is received, a frame memory writing control portion 5b designates destinations in a frame memory 1 to which image data are to be written, in order opposite to the regular order.

In a case where the writing destinations are designated in an ascending order of bit numbers starting from one bit number in blocks M1 to M4 of the frame memory 1 for a normal display, for example, the control portion 5b designates writing destinations in a descending order of bit numbers, when conduct right and left reversing display is instructed.

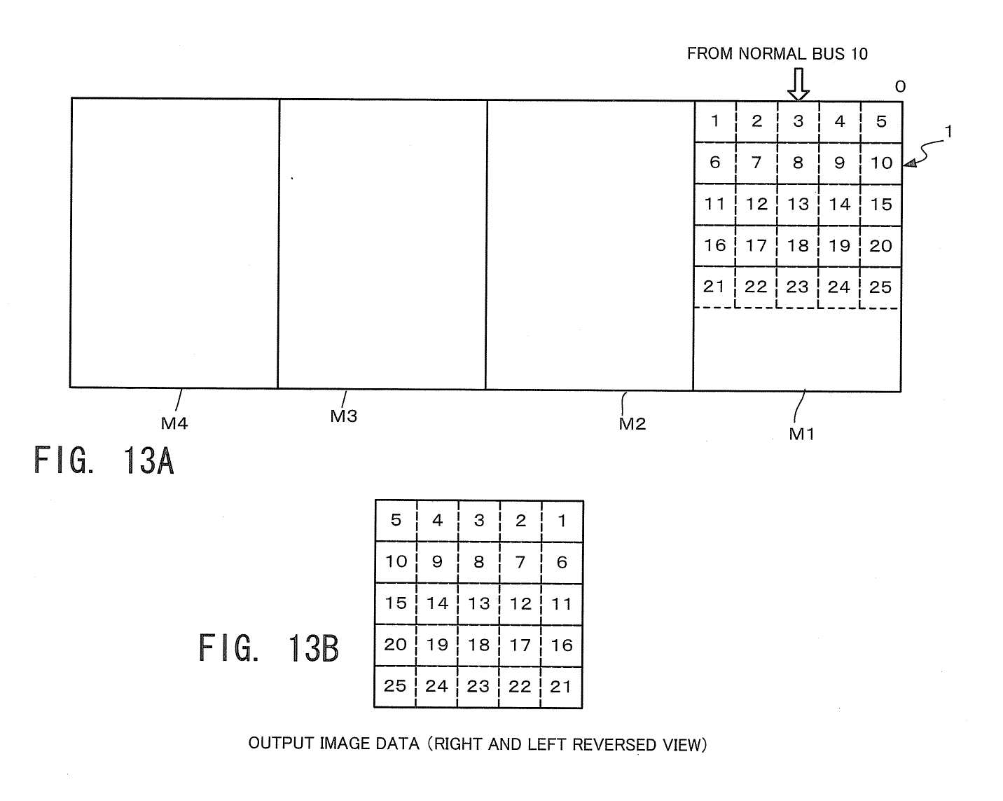

FIG. 13A shows an example of writing image data into the frame memory 1 when the frame memory writing control portion 5b is received the right and left reversing command signal. This example is based on the assumption that image data such as that shown in FIG. 2C is outputted to a normal bus 10.

As shown in FIG. 13A, pixel data are arranged in each line of the frame memory 1 in an order opposite to that at the time of normal display shown in FIG. 3A.

Therefore, an image read from the frame memory 1 by the frame memory reading control portion 7 is displayed right and left reversely as shown in FIG. 13B with respect to the normal display shown in FIG. 3B.

When a top and bottom reversing command signal is received, an address control portion 6a generates addresses in order opposite to the normal case.

The address control portion 6a normally generates addresses in a direction from an initial address toward a final address but, if instructed to conduct top and bottom reversed display, generates the addresses in an order from the final address toward the initial address.

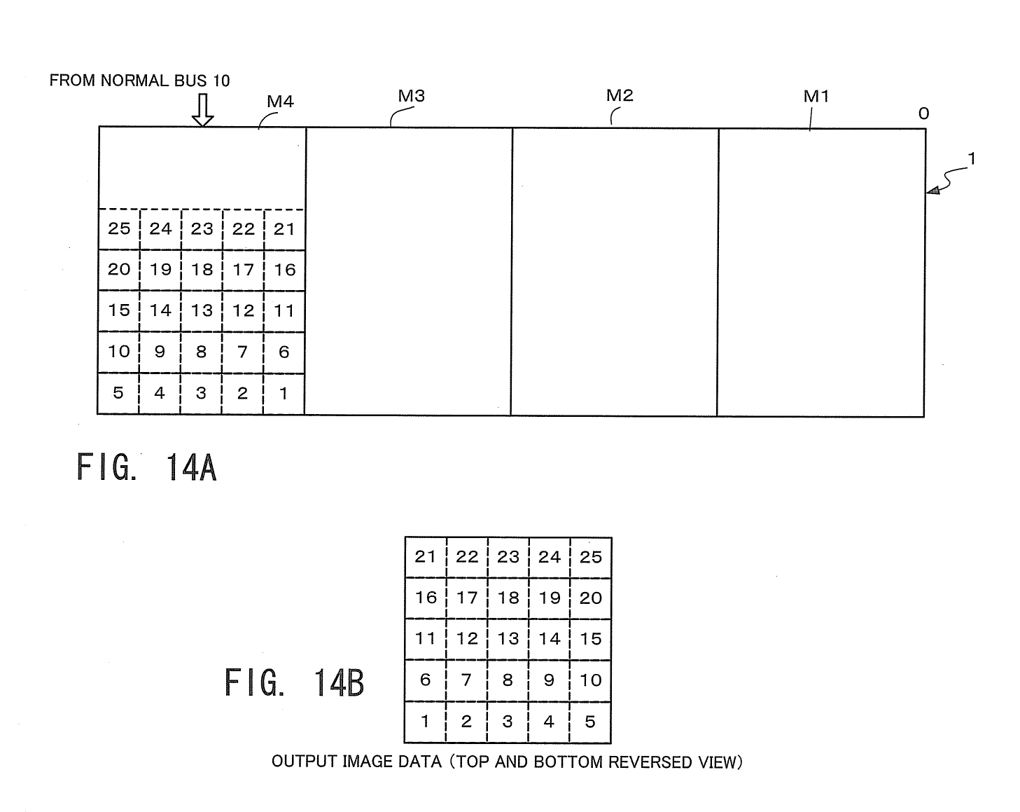

FIG. 14A shows an example of writing image data into the memory block M4 of the frame memory 1 when the address control portion 6a is received the top and bottom reversing command signal. This example is based on the assumption that pixel data of the image data such as that shown in FIG. 2C is outputted to the normal bus 10.

In this example, the final address is the bottom line of the memory block M4 in the frame memory 1, so that the image data output to the normal bus 10 is written upward starting from the bottom line of the memory block M4.

Therefore, the image data read from the frame memory 1 by the frame memory reading control portion 7 is as shown in FIG. 14B. The image data in FIG. 14B is top and bottom reversed with respect to the normal image data shown in FIG. 3B.

In the embodiment, it is possible to write the data for displaying right and left reversed images and the data for displaying top and bottom reversed images into the frame memory 1 easily.

The above embodiments are described with the example where command signals which instruct various types of display are inputted independently on each other. It is possible to input command signals simultaneously which instruct a plurality of types of display, and to perform processing collectively in accordance with the command signals so as to write results of the processing into the frame memory 1.

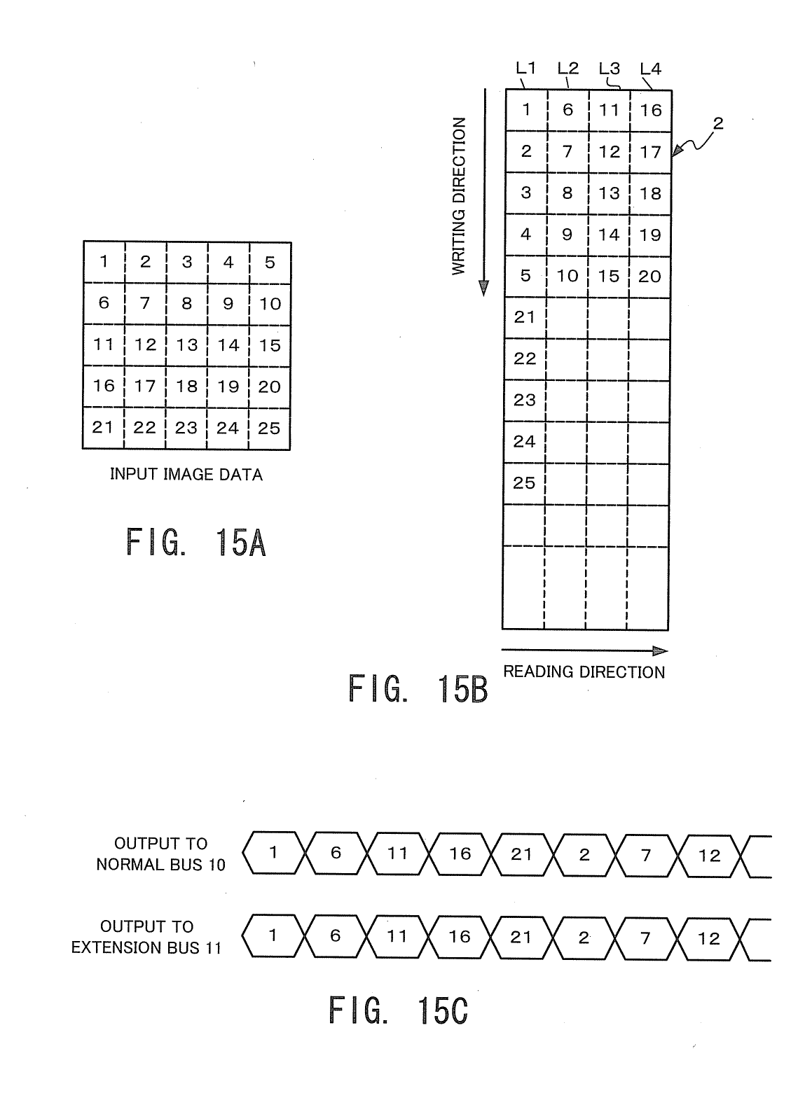

For example, operations to be performed in a case will be described. The case is that it is requested that input image should be rotated by 90 degrees clockwise and magnified fourfold, and then data of a right and left reversed image should be written into a frame memory 1, in the semiconductor integrated circuit of the fourth embodiment, with reference to FIGS. 15A to 15C, 16, and 17.

In accordance with the 90-degree clockwise rotation command signal, the line buffer writing control portion 3 writes an input image pixel data 1 to 25 shown in FIG. 15A in the address direction as shown in FIG. 15B.

Subsequently, in accordance with the image magnification command signal, the line buffer reading control portion 4 reads the image data from the line buffer 2, and, as shown in FIG. 15C, outputs the read image data to the normal bus 10 and the extension bus 11 simultaneously.

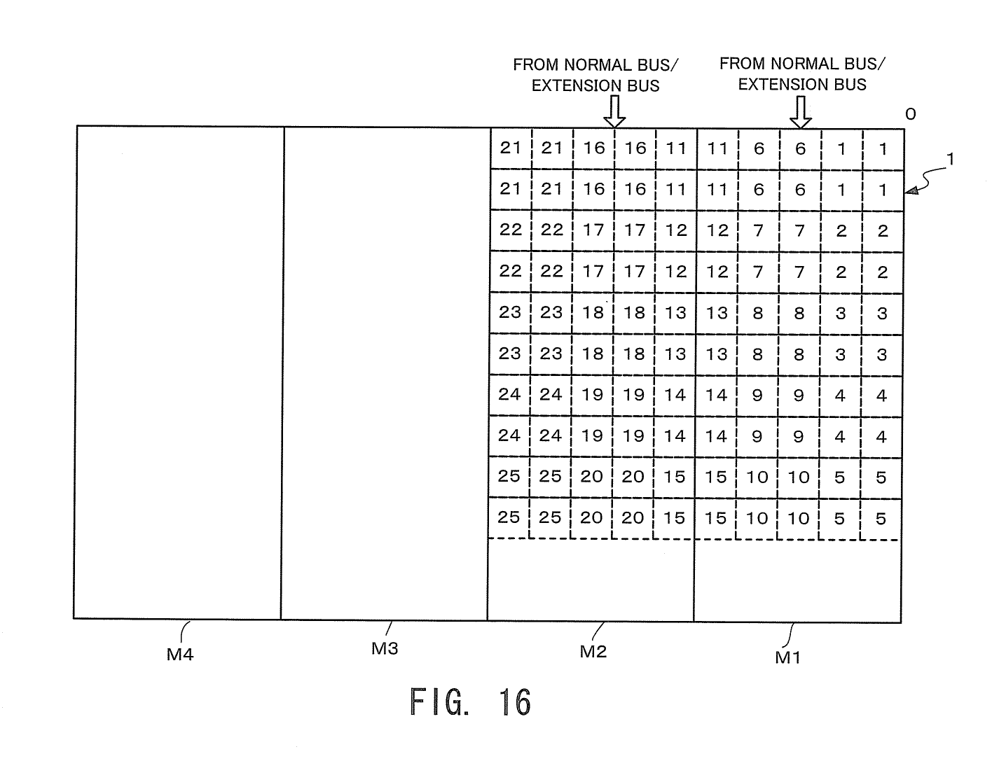

In accordance with the image magnification command signal and the right and left reversing display command signal, the frame memory writing control portion 5b controls writing bit positions in the frame memory 1 so that destinations to which the image data output to the normal bus 10 and the extension bus 11 are to be written may neighbor each other horizontally in FIG. 16, and so that the pixel data is arranged in the lines of the frame memory 1 in order opposite to the normal order.

On the other hand, the address control portion 6a sequentially selects a pair of vertically consecutive addresses in FIG. 16 in accordance with the image magnification command.

As a result, as shown in FIG. 16, the data of an image obtained by rotating the input image 90 degrees clockwise and magnifying the image fourfold and then right and left reversing the image is written into the memory blocks M1, M2 of the frame memory 1.

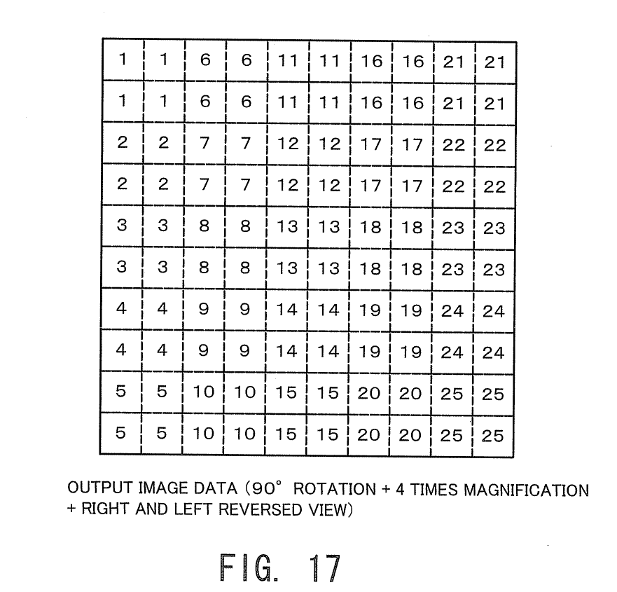

In order to display the image, the frame memory reading control portion 7 reads the image data from the memory blocks M1, M2 in the frame memory 1 alternately. The image data read from the frame memory 1 corresponds to the image obtained by rotating the input image by 90 degrees clockwise, by magnifying the image four times and further by right and left-reversing the image, as shown in FIG. 17.

As described above, in response to the instruction for processing a plurality of types of image display, those types of image display can be processed collectively and the processed image data can be written into the frame memory. Therefore, it is possible to keep up almost the same writing efficiency as that in the case of processing a single type of image display.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A semiconductor integrated circuit comprising:
a normal bus;
an extension bus having the same bit width as the normal bus;
a frame memory having a memory width equal to an integer multiple of the number of bits of the normal bus;
a line buffer having a plurality of line regions to store pixel data of input image data;
a line buffer writing control portion to control a direction in which the pixel data is to be written to the line buffer;
a line buffer reading control portion to read out the pixel data stored in the line buffer and to output the read out pixel data to the normal bus and the extension bus selectively;
a frame memory writing control portion to control a destination in the frame memory to which the pixel data obtained from the normal bus and the extension bus is to be written; and
an address control portion to control a writing address in the frame memory,
wherein the line buffer writing control portion controls the writing direction in the line buffer in accordance with an image rotation command signal, the line buffer reading control portion divides the read out pixel data and outputs the divided pixel data to the normal bus and the extension bus respectively, and the frame memory writing control portion controls the writing destination in the frame memory of the pixel data obtained from the normal bus and the extension bus.

2. The semiconductor integrated circuit according to claim 1, further comprising a frame memory reading control portion to read out the pixel data stored in the frame memory and sends the read out pixel data to a display device.

3. The semiconductor integrated circuit according to claim 1, wherein the direction, in which the pixel data is to be written in the line buffer by the line buffer writing control portion, is an address direction of the line buffer.

4. The semiconductor integrated circuit according to claim 3, wherein the line buffer reading control portion outputs the pixel data stored in the line buffer to the normal bus and the extension bus alternately.

5. The semiconductor integrated circuit according to claim 3, wherein the frame memory includes a plurality of memory blocks, and the frame memory writing control portion stores the pixel data obtained from the normal bus and the extension bus separately in two memory blocks of the memory blocks.

6. The semiconductor integrated circuit according to claim 1, further comprising an address control portion,
wherein when an image magnification command signal is received, the line buffer writing control portion conducts control so that the writing direction of the pixel data in the line buffer coincides with the reading direction of pixel data stored in the line buffer in the case of normal display, the line buffer reading control portion outputs the identical pixel data to the normal bus and the extension bus, the frame memory writing control portion writes the respective pixel data obtained from the normal bus and the extension bus into the frame memory such that the respective pixel data neighbor each other alternately, and the address control portion conducts control so that the identical pixel data is written to a plurality of addresses of the frame memory.

7. The semiconductor integrated circuit according to claim 6, wherein the frame memory writing control portion writes the pixel data obtained from the normal bus and the extension bus into the frame memory in a frame memory width direction, and the address control portion controls a position to which the pixel data is to be written in a column direction in the frame memory.

8. The semiconductor integrated circuit according to claim 1, wherein the frame memory includes a plurality of memory blocks, and the frame memory writing control portion stores the identical image data obtained from one of the normal bus or the extension bus into plural ones of the memory blocks when an image copy command signal is received,.

9. The semiconductor integrated circuit according to claim 1, wherein the pixel data of the input image data are outputted to the normal bus and the extension bus directly, when at least one of an image magnification command signal or an image copy command signal is received.

10. The semiconductor integrated circuit according to claim 2, wherein the frame memory reading control portion reads out the pixel data stored in the frame memory in a direction reversed from a normal direction along the frame memory width when a right and left reversing command signal is received.

11. The semiconductor integrated circuit according to claim 2,
wherein
the frame memory includes a plurality of memory blocks,
the frame memory writing control portion writes pixel data obtained through at least one of the normal bus or the extension bus from a most lower line to a most upper line in one of the memory blocks, one after another, and
the frame memory reading control portion reads out the pixel data stored in the one of the memory blocks in a direction reversed from a direction along the frame memory width.
